(19) United States
(12) Patent Application Publication
(10) Pub. No.: US 2015/0158255 A1
(43) Pub. Date: Jun. 11, 2015

(54) METHOD FOR OBTAINING LAMINAS MADE OF A MATERIAL HAVING MONOCRYSTALLINE STRUCTURE

(71) Applicant: David Callejo Munoz, Milan (IT)

(72) Inventor: David Callejo Munoz, Milan (IT)

(21) Appl. No.: 14/481,691

(22) Filed: Sep. 9, 2014

(30) Foreign Application Priority Data
Dec. 5, 2013 (IT) AN2013A000232

(51) Int. Cl. B29C 69/00

(52) U.S. Cl. CPC B29C 69/001; B29L 2007/00

(57) ABSTRACT

A method is described for obtaining a plurality of laminas, made of a material having monocrystalline structure, from an ingot made of the material having monocrystalline structure, the ingot having a distal end and an axis of symmetry (X), the method comprising: creating, in the ingot by use of a pulsed laser beam, a plurality of sacrificial layers with modified crystalline structure, the plurality of sacrificial layers being distributed along the axis of symmetry (X), the plurality of sacrificial layers dividing the ingot in a plurality of intermediate layers with altered thermal coefficient; and thermally causing the sequential or simultaneous breakage of the sacrificial layers to produce the plurality of laminas made of a material having monocrystalline structure.

### PRIORITY FOREIGN PATENT APPLICATION

This is a non-provisional national phase U.S. patent application claiming priority to a pending Italian patent application, Serial No. AN2013A000232, filed in Italy on Dec. 5, 2013 with a common inventive entity. This present U.S. patent application draws priority from the referenced foreign patent application under 35 U.S.C §119. The entire disclosure of the referenced foreign patent application is considered part of the disclosure of the present U.S. patent application and is hereby incorporated by reference herein in its entirety.

### DESCRIPTION

The following is a description of a process for obtaining laminas, made of a material having monocrystalline structure, from an ingot made of a material having a monocrystalline structure.

For the purposes of the present description, the term “lamina” means an element having two large surfaces and a thickness of between 10 μm and 1500 μm.

The term “lamina” includes elements with two large surfaces that can be flat and substantially and/or generally parallel to each other.

For the purposes of the present description, the term “lamina made of crystalline material” includes crystalline materials having, on their two large surfaces which are flat and parallel to each other, the same crystallographic orientation.

The term “lamina” also includes elements in which at least one of the two large surfaces is generally curved and elements in which both of the large surfaces are generally curved, even with different radii of curvature.

For the purposes of the present description, the term “material having monocrystalline structure” includes synthetic corundum.

For the purposes of the present description, the term “ingot” includes bodies having an axis of symmetry and a cross-section that, at least in one section, is substantially and/or generally constant.

Corundum is a transparent material, with chemical formula Al2O3, which crystallizes in the trigonal system.

In nature, corundum is usually coloured, due to the presence of impurities.

Among the different varieties of corundum found in nature are, in particular, ruby (whose red colour is due to the presence of chromium) and sapphire (whose dark blue colour is due to the presence of iron and titanium).

Methods for synthesizing corundum ingots are also known.

For example, corundum can be produced in the laboratory in the form of cylindrical bars by means of melt growth techniques, such as the Czochralski method, the Kyroupolus method, or in various forms, by means of the Stephanov method.

Corundum has some interesting physico-chemical properties: high hardness (second only to that of diamond), high chemical inertia and excellent transparency.

Synthetic corundum, in the form of laminas, thanks to its high breaking strength and scratch resistance and its high chemical inertia, can be used, for example, to make transparent screens, such as screens of transparent lamination layers in which at least one of the lamination layers is composed of corundum.

Corundum can therefore be used to make screens for optical sensors (destined to be exposed to aggressive external agents) and transparent protective screens for the monitors of electronic devices, such as sat nays, laptop computers, smartphones and tablets.

However, the physico-chemical properties for which corundum is valued, such as hardness and chemical inertia, make its machining, particularly cutting and machining operations (such as lapping) aimed at reducing its surface roughness, complex and expensive.

Traditional systems for cutting corundum laminas are based on using multi-wire saws with diamond metal wire.

This technology requires long machining times and is quite expensive.

As an example, it takes about 18 hours of machining to cut 200 laminas of corundum, with a cross-section of about 150 mm and a thickness of 1 mm.

Due to the costs of the equipment, consumables (particularly the consumption of diamond wire) and the work time, the overall cost of cutting corundum laminas (excluding the material) is so high as to make corundum uncompetitive compared with other materials such as Gorilla® glass.

Another drawback of using diamond wire to cut corundum laminas is that, in fact, it is not possible to obtain corundum laminas less than about 500 μm thick (below this thickness threshold the frequency of rejects drastically increases).

At ambient temperature for thicknesses of more than 450-500 μm, corundum laminas have a substantially rigid behaviour.

This means that with the technology of cutting by means of diamond wire it is possible to obtain only substantially rigid corundum laminas

However, the tendency of the latest generations of monitors for electronic devices, such as smartphones, is to adopt curved geometries (portions of cylindrical surfaces for example).

Below the threshold of 450 μm, the corundum laminas begin gradually to have an increasingly more flexible behaviour with a minimum radius of curvature inversely proportional to the thickness of the lamina.

In particular, below 400 μm thick corundum laminas start to have sufficient flexibility to enable them to be used to make monitors with a curved geometry.

Consequently, it is not possible to make monitors with corundum screens, with curved geometries, by adopting the technology of cutting by means of diamond wire.

Another drawback of the technology of cutting by means of diamond wire is the fact that the laminas obtained can only be laminas with flat large surfaces parallel to each other.

Yet another drawback of the technology of cutting by means of diamond wire is the fact that the mechanical process of cutting causes structural damage beneath the surface of the material (so-called “subsurface damage”) of a depth proportional to the particle size of the diamond dust present on the cutting wire.

This thickness, indicatively 30 μm on each side of the cut sheet, must be removed before polishing said sheet.

Consider also that the machining required to reduce surface roughness, in addition to requiring time, is very delicate in that it can cause irreparable damage to the corundum sheet.

It will also be remembered that corundum has a high density (around 4 g/cm3).

With the thicknesses obtainable using the existing cutting technology, the protective monitor screens, if made using corundum sheet-like elements, would be heavier than the monitors made using Gorilla® glass and therefore of little interest to the consumer electronics market, particularly in the case of monitors for portable devices such as laptops and smartphones.

Furthermore, cutting with diamond wire involves a waste of material, in the best cases, of at least 180-200 μm, which means that to obtain, for example, 200 1 mm-thick corundum laminas, an ingot of a length of at least 240 mm is required.

The inventor's aim is to resolve, at least in part, at least some of the problems of the prior art and, in particular, the problems mentioned above.

The inventor's aim is achieved by means of a method according to claim 1.

Further advantages can be obtained by means of the additional characteristics of the dependent claims.

A possible embodiment of a method for obtaining a crystalline material in the form of laminas will be described below with reference to the accompanying drawings, in which:

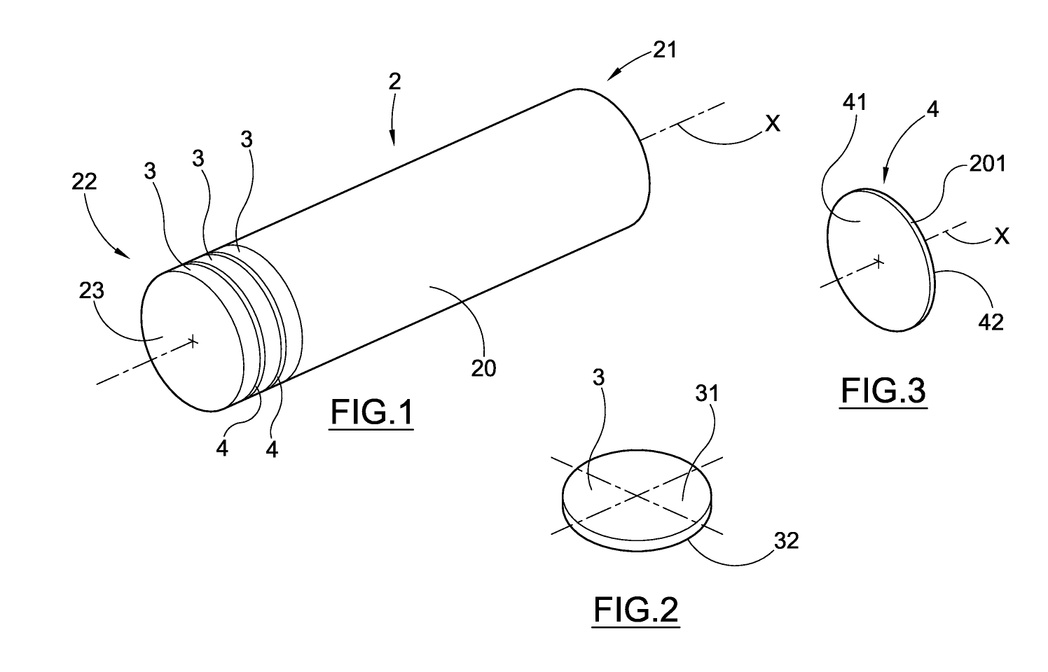

FIG. 1 is a schematic view of a corundum ingot;

FIG. 2 is a schematic view of a corundum lamina obtained from the ingot of FIG. 1;

FIG. 3 is a schematic view of a sacrificial layer made in the ingot of FIG. 1;

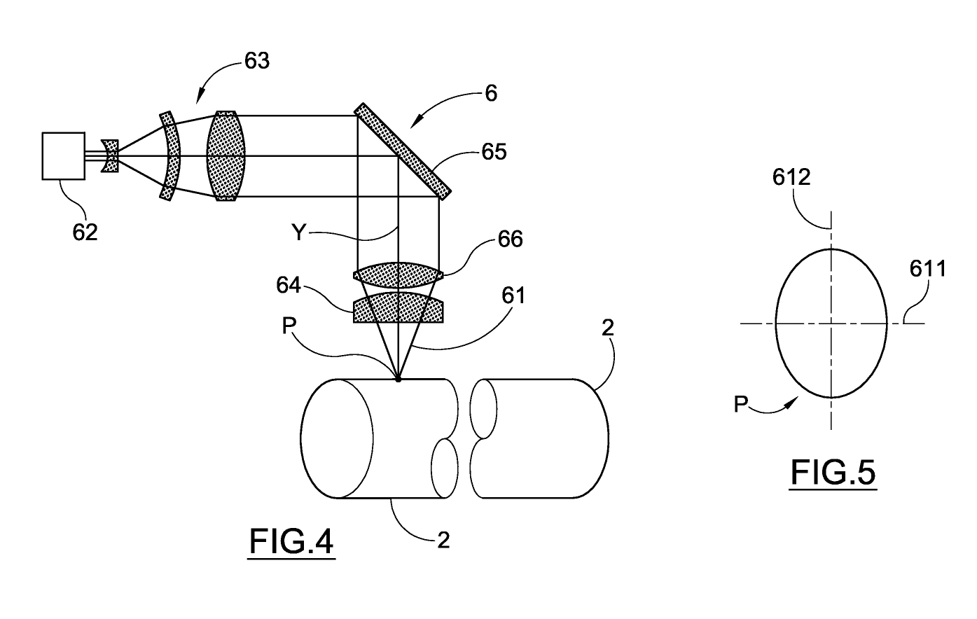

FIG. 4 is a schematic view of a laser device for creating sacrificial layers in the ingot of FIG. 1; and

FIG. 5 is a schematic view of a focal point obtained with a pulsed laser.

With reference to the accompanying drawings, a method is described for obtaining a plurality of laminas 3, 3, . . . 3 made of a material having a monocrystalline structure, such as corundum.

The plurality of laminas 3, 3, . . . 3 is obtained from an ingot 2 made of monocrystalline material having an axis of symmetry X, a lateral surface 20, which develops around the axis of symmetry X of said ingot 2, a first distal end 21 and a second distal end 22 (crossed by the axis of symmetry X).

In the embodiment illustrated, the ingot 2 has a substantially and/or generally straight axis of symmetry X and a cross-section that, at least in one section, is substantially and/or generally constant.

In a possible embodiment of the method, the ingot 2 is a bar of monocrystalline corundum, for example a bar of corundum with a circular or rectangular section obtained by means of the Czochralski process.

At least one distal end 22 of the ingot 2 can have a surface 23 that is substantially flat and/or generally orthogonal to the axis of symmetry X of the ingot 2.

The flat surface 23 can be obtained, for example, by cutting, with a diamond wire, a distal end of a corundum bar 2 obtained using the Czochralski method.

To obtain a plurality of laminas 3 from the ingot 2 the step of creating a plurality of sacrificial layers 4, 4, . . . 4 that develop in a manner substantially and/or generally orthogonally to the axis of symmetry X of the ingot 2 is envisaged.

The sacrificial layers 4, 4, . . . 4 have a modified thermal expansion coefficient compared to that of the original monocrystalline material and are distributed along the axis of symmetry (X) of the ingot 2 so as to define a plurality of intermediate layers 3, 3, . . . 3, with an unchanged thermal coefficient, interspersed with the sacrificial layers 4, 4, . . . 4.

The distance between the successive sacrificial layers 4, 4 determines the thickness of the intermediate layers 3 and, therefore, the thickness of the laminas that is desired.

The form of each intermediate layer 3 is conjugated to the forms of each pair of sacrificial layers 4, 4 between which the intermediate layer 3 is located.

In the example illustrated, each sacrificial layer 4 is delimited by two flat surfaces 41, 42 that are parallel to each other and orthogonal to the axis X of the ingot, and by a portion 201 of the lateral surface 20 of the ingot 2, located between the intersections of the two flat surfaces 41, 42 with the lateral surface 20.

By means of a heating process, the sacrificial layers 4, 4, . . . 4 are broken and laminas 3, 3, . . . 3 formed by the intermediate layers interposed between the sacrificial layers are created.

As better illustrated below, the thermal process causes the breakage, sequential or contemporaneous, of the sacrificial layers 4, 4, . . . 4 and the consequent creation, sequential or contemporaneous, of a plurality of laminas 3, 3, . . . 3 made of monocrystalline material.

The plurality of sacrificial layers 4, 4, . . . 4, with a modified thermal expansion coefficient compared to the thermal expansion coefficient of the original monocrystalline structure, is obtained by irradiating the ingot 2 with a pulsed laser beam 61 (also known as “femtosecond laser” or “ultrafast laser”).

The pulsed laser creates a modification of the crystalline structure which, in turn, causes a variation of the thermal expansion coefficient inside the sacrificial layer 4.

In order to create the sacrificial layer 4, the crystalline material must be irradiated with a pulsed laser beam 61 (so-called “femtosecond laser” or “ultrafast laser”).

For this purpose a laser generator 6 is provided, which comprises a laser source 62, a system for transporting the laser beam 63, a focuser 64 and a system for moving the laser beam 65.

The pulsed laser beam 61 has an optical axis Y on which there is a focal point P.

The pulsed laser beam 61 has a sufficiently high pulse power/average power ratio to minimise the induced thermal load on the material of the ingot 2 and thus limit the transmission of heat.

At focal point P, where the light energy is concentrated, the crystalline material suffers structural damage and, consequently, a variation in the thermal expansion coefficient.

Although not wishing to provide a scientific explanation, it is thought that the high energy density, in a time in the order of femtoseconds, generates micro-explosions that create micro-fractures and/or transform the crystalline structure from monocrystalline to polycrystalline, thus modifying the thermal expansion coefficient of the crystalline material.

By scanning (in depth) the ingot 2 with the focal point P, sacrificial area 4 is created (with modified crystalline structure and consequent modified thermal expansion coefficient compared to that of the base material).

The system for moving the laser beam 61 may comprise a complex optical system, with a variable-focus lens 66 and one and/or more movable mirrors 65, to alter the depth of the focal point P in the ingot 2.

In order to scan the focal point P inside the ingot 2 a system of alternating linear rotation or movement of the ingot 2 (not shown) may be provided.

At the focal point P the laser beam 61 may have an elliptical section, with a small axis 611 (parallel to the axis of symmetry X of the ingot 2) and a large axis 612 (orthogonal to the axis of symmetry X of the ingot 2).

The size of the small axis 611 is as small as possible, so as to minimise the thickness of the sacrificial layer 4, whereas the maximum size of the large axis 612 is such as always to maintain a density of light output such as to damage the crystalline structure of the material of the ingot 2.

In a possible embodiment, the small axis 611 measures about 2 μm while the large axis 612 measures about 30 μm.

Since the material is destined to be sacrificed, the thickness of the sacrificial layer 4 is as small as possible.

In practice the average thickness of the sacrificial layer 4 can be between 2 μm and 10 μm.

The interaction between the laser beam and the material of the ingot 2 is influenced by the absorption coefficient of the corundum which, in turn, depends on the wave length of the incident radiation.

In a possible embodiment of the method, the pulsed laser beam 61 used to create the sacrificial layer 4 has a wavelength λ in the range between 200 nm and 1,100 nm.

Preferably the pulsed laser beam 61 has a wavelength λ of about 258 nm, 343 nm, 515 nm, 780 nm, 800 nm or 1,030 nm.

The repetition frequency τ of the pulsed laser beam 61 is at least 10 kHz and, preferably, is higher than 1 MHz.

The duration τ of the pulses of the laser beam 61 is between 1×10⁻¹² seconds and 1×10⁻¹¹ seconds and, preferably, between 1×10⁻¹² and 1×10⁻¹⁰ seconds.

The peak energy density of the pulsed laser beam is at least 0.5 poules/μm2.

Thanks to the very short duration of the pulses of the pulsed laser beam 61 and to the high surface density, there is a non-linear interaction of absorption of the photons, which causes an alteration of the properties of the irradiated material at the area of the focal point P.

According to a first variation of the method, the breakage of the sacrificial layers 4, 4, . . . 4 occurs by creating a spatial temperature gradient along the axis of symmetry of the ingot 2.

For this purpose, a distal end 22 of said ingot 2 is heated so as to generate a temperature gradient along the axis X which passes through the sacrificial layers 4, 4, . . . 4 in succession causing the breakage, in succession, of the sacrificial layers and thus the creation of the laminas 3, 3, . . . 3.

By causing a sufficiently high spatial thermal gradient, the stresses inside the sacrificial layer 4 reach sufficiently high values to exceed the breaking stresses, causing the fracture of the sacrificial layer 4.

In practice, the spatial thermal gradient must have a value of at least 100° C./mm.

The distal end 22 of the ingot 2 is heated to a temperature in the range between 600° C. and 1,300° C., for example by means of an electric heating element or by a CO2 laser.

Heating can occur, for example, by irradiation using an electrically-heated metal plate, or by exposure to an infrared laser, such as a CO2 laser.

During heating of the distal end 22, the sacrificial layer 4 closest to the distal end 22 is stressed in compression by the intermediate layer 3 which is at a higher temperature, and is stressed in traction by the intermediate layer 3 which is at a lower temperature.

This causes a breakage of the ingot 2, due to thermal load, at the sacrificial layer.

On the basis of this first variation of the method, the laminas made of monocrystalline material 3, 3, . . . 3 are detached sequentially from the distal end 22.

According to an alternative embodiment of the method, the breakage of the sacrificial layers occurs by creating a temporal temperature gradient inside the ingot 2, uniform until causing the contemporaneous breaking of the sacrificial layers 4, 4, . . . 4.

In this alternative version of the method, the ingot 2 is heated to a temperature in the range between 600° C. and 1,300° C. and the temporal thermal gradient must be at least 1° C./minute.

The thermal gradient, spatial or temporal, passes through the sacrificial layer 4, (in which the thermal expansion coefficient has been modified), and the areas adjacent to the sacrificial layer 4 (in which the thermal expansion coefficient has remained unchanged).

By means of the two variations of the method described above it is possible to obtain corundum laminas 3 with a minimum thickness of 10 μm.

It is thus possible to obtain corundum laminas of a thickness suitable to make transparent screens with a curved geometry that are scratch resistant and have a higher breaking strength than that of state-of-the-art screens (such as Gorilla® glass).

The lamina 3 thus obtained has no subsurface damage and has lower roughness which is a function of the small diameter 611 of the laser beam, in practice the surface roughness is less than 1 μm.

1. A method for obtaining a plurality of laminas, made of a material having monocrystalline structure, from an ingot made of the material having monocrystalline structure, the ingot having a distal end and an axis of symmetry (X), the method comprising:
creating, in the ingot by use of a pulsed laser beam, a plurality of sacrificial layers with modified crystalline structure, the plurality of sacrificial layers being distributed along the axis of symmetry (X), the plurality of sacrificial layers dividing the ingot in a plurality of intermediate layers with altered thermal coefficient; and
thermally causing the sequential or simultaneous breakage of the sacrificial layers to produce the plurality of laminas made of a material having monocrystalline structure.

2. The method according to claim 1 wherein the material having monocrystalline structure includes a material from the group consisting of: corundum, sapphire, diamond, ruby, quartz, silicon, silicon carbide, carborundum, fluorite, copper, germanium, gallium nitride, gallium arsenide, indium phosphide, padparadscha, tungsten, molybdenum oxide, and yttrium aluminum garnet (YAG).

3. The method according to claim 1 wherein the plurality of laminas each include at least two large generally parallel flat surfaces having a generally constant thickness and the same crystallographic orientation.

4. The method according to claim 1 wherein the plurality of laminas each include at least two large curved surfaces having a generally constant thickness and the same crystallographic orientation.

5. The method according to claim 1 wherein the plurality of laminas each include at least two large curved surfaces having a generally constant thickness and the same crystallographic orientation, the at least two large curved surfaces being curved in at least two dimensions.

6. The method according to claim 1 wherein the plurality of laminas each include at least two non-parallel surfaces.

7. The method according to claim 1 wherein the plurality of laminas each have a thickness of at least 10 μm.

8. The method according to claim 1 wherein the plurality of laminas each have a roughness of less than 2 μm.

9. The method according to claim 1 wherein the sacrificial layers are substantially parallel to each other.

10. The method according to claim 1 wherein the sacrificial layers have a modified crystalline structure with a modified thermal expansion coefficient.

11. The method according to claim 1 wherein the sacrificial layers each have a thickness no greater than 10 μm.

12. The method according to claim 1 wherein the pulsed laser is a femtosecond laser producing the pulsed laser beam with a femtosecond pulse duration.

13. The method according to claim 1 wherein the pulsed laser beam has a wavelength (λ) less than 1,100 nm, a repetition frequency (f) of at least 10 KHz, a pulse duration (τ) less than 1×10⁻¹⁰ seconds, and a peak energy density of at least 0.5 poules/μm².

14. The method according to claim 13 wherein the wavelength (λ) corresponds to one of the following values: 258, 343, 515, 780, 800, 1030 nm, and wherein the repetition frequency (f) is higher than 1 MHz, and wherein the duration (τ) of the pulses is in the range between 1×10⁻¹² seconds and 1×10⁻¹⁰ seconds.

15. The method according to claim 1 including using a variable-focus lens to alter the depth of the focal point of the pulsed laser beam in the ingot.

16. The method according to claim 1 including using a variable-focus lens to alter the focal point of the pulsed laser beam to produce a beam with an elliptical section having a large axis orthogonal to the axis of symmetry (X) of the ingot.

17. The method according to claim 1 wherein the distal end of the ingot is heated to generate a temperature gradient along the axis of symmetry (X), which crosses the plurality of sacrificial layers in a succession, the temperature gradient causing the breakage of the sacrificial layers of the ingot.

18. The method according to claim 1 wherein the distal end of the ingot is heated to a temperature less than 1,300° C.

19. The method according to claim 1 wherein the ingot is heated in a generally even manner to cause the simultaneous breakage of the sacrificial layers.

20. The method according to claim 1 wherein the laminas made of monocrystalline material are detached sequentially from the distal end using a mechanical process.

21. The method according to claim 1 including using the plurality of laminas as transparent protective screens for the monitors of electronic devices with a flat or curved geometry.
